(19) United States
(12) Patent Application Publication
(10) Pub. No.: US 2024/0383356 A1
(43) Pub. Date: Nov. 21, 2024

(54) CHARGING APPARATUS TO BE MOUNTED TO ANOTHER STRUCTURE, TO PROVIDE ITS OWN CIRCUIT BREAKER, AND TO PROTECT A CABLE

(71) Applicant: EATON INTELLIGENT POWER LIMITED, DUBLIN 4 (IE)

(72) Inventors: Advait Madhusudan Katarki, Pittsburgh, PA (US); Robert J. Reese, Edwardsville, IL (US)

(73) Assignee: EATON INTELLIGENT POWER LIMITED, DUBLIN 4 (IE)

(21) Appl. No.: 18/689,566

(22) PCT Filed: Dec. 9, 2022
(86) PCT No.: PCT/EP2022/025425

§ 371 Date: Mar. 6, 2024

Related U.S. Application Data
(60) Provisional application No. 63/245,240, filed on Sep. 17, 2021.

(51) Int. Cl. B60L 53/31; B60L 53/16; B60L 53/18

(52) U.S. Cl. CPC B60L 53/31; B60L 53/16; B60L 53/18

(57) ABSTRACT

A charging apparatus is mountable to another structure and to be electrically connected with a source of electrical power. It includes a housing, a cable apparatus, and an electrical apparatus electrically connected with the source of electrical power to provide electrical power to an electric vehicle. The electrical apparatus can include a circuit interrupter apparatus including a circuit interrupter situated within an interior of the housing. The housing can include a retaining portion that protrudes outwardly from a perimeter of a base portion of the housing and is structured to retain at least a portion of the cable between the retaining portion and another structure to which the charging apparatus is mounted when the cable is at least in part wrapped about the perimeter.

### BACKGROUND

### Field

The disclosed concept relates generally to charging structures and, more particularly, to a charging apparatus that is configured to be mounted to another structure, to provide its own circuit breaker and/or to hold a cable thereon.

### Background Information

Numerous types of systems are known for enabling the charging of mobile electrical devices, particularly electrical vehicles. A typical system includes a source of electrical power that is delivered at the end of a cable which can be connected to a vehicle. However, such systems typically are connected with systems that include remote circuit breakers that can be difficult for a user to manage and that further employ charging cables that are connectable with electrical vehicles to provide electrical charging but the cables are unmanaged and end up resting on a floor. Improvements thus would be desirable.

### SUMMARY

These needs and others are met by embodiments of the invention. In one aspect of the disclosed and claimed concept, an improved charging apparatus is structured to be mounted to another structure and to be electrically connected with a source of electrical power and can be generally stated as including a housing, a cable apparatus that can be generally stated as including a cable and a connector that are electrically connected together, the cable extending from the housing, an electrical apparatus situated on the housing and structured to be electrically connected with the source of electrical power, the cable apparatus being electrically connected with the electrical apparatus and being structured to provide electrical power from the source of electrical power to an electric vehicle, and the electrical apparatus can be generally stated as including a circuit interrupter apparatus situated on the housing, the circuit interrupter apparatus can be generally stated as including a circuit interrupter that is electrically connected with the cable and that is movable between at least an ON state wherein the cable is electrically connected with the source of electrical power and at least one of an OFF state and a TRIPPED state wherein the cable is electrically disconnected from the source of electrical power.

In another aspect of the disclosed and claimed concept, an improved charging apparatus is structured to be mounted to another structure and to be electrically connected with a source of electrical power and can be generally stated as including a housing, a cable apparatus that can be generally stated as including a cable and a connector that are electrically connected together, the cable extending from the housing, an electrical apparatus situated on the housing and structured to be electrically connected with the source of electrical power, the cable apparatus being electrically connected with the electrical apparatus and being structured to provide electrical power from the source of electrical power to an electric vehicle, the housing having a base portion that is structured to be mounted to the another structure, the base portion having a mounting surface that is structured to be mounted to the another structure, and the housing further can be generally stated as including a retaining portion that is situated on the base portion and is spaced from the mounting surface, at least a portion of the retaining portion protruding outwardly from a perimeter of the base portion and being structured to retain at least a portion of the cable between the retaining portion and the another structure when the mounting surface is mounted to the another structure and when the cable is at least in part wrapped about the perimeter.

### BRIEF DESCRIPTION OF THE DRAWINGS

A full understanding of the disclosed concept can be gained from the following Description when read in conjunction with the accompanying drawings in which:

FIG. 1 is a perspective view of an improved charging apparatus in accordance with the disclosed and claimed concepts having a first portion situated on a wall and having a second portion with a cover portion thereof in an open condition, with it being schematically depicted as being electrically connectable with an electric vehicle;

FIG. 2 is a side elevational view of the charging apparatus of FIG. 1;

FIG. 3 is a top plan view of the charging apparatus of FIGS. 1 and 2;

FIG. 4 is a front elevational view of the charging apparatus of FIGS. 1-3 with the second portion thereof removed from the first portion;

FIG. 5 is a perspective view of the charging apparatus of FIGS. 1-4 showing the second portion thereof exploded away from the first portion; and

FIG. 6 is a view of the charging apparatus similar to FIG. 1, except depicting the cover portion thereof in a closed condition.

Similar numerals refer to similar parts throughout the specification.

### DESCRIPTION OF THE PREFERRED EMBODIMENTS

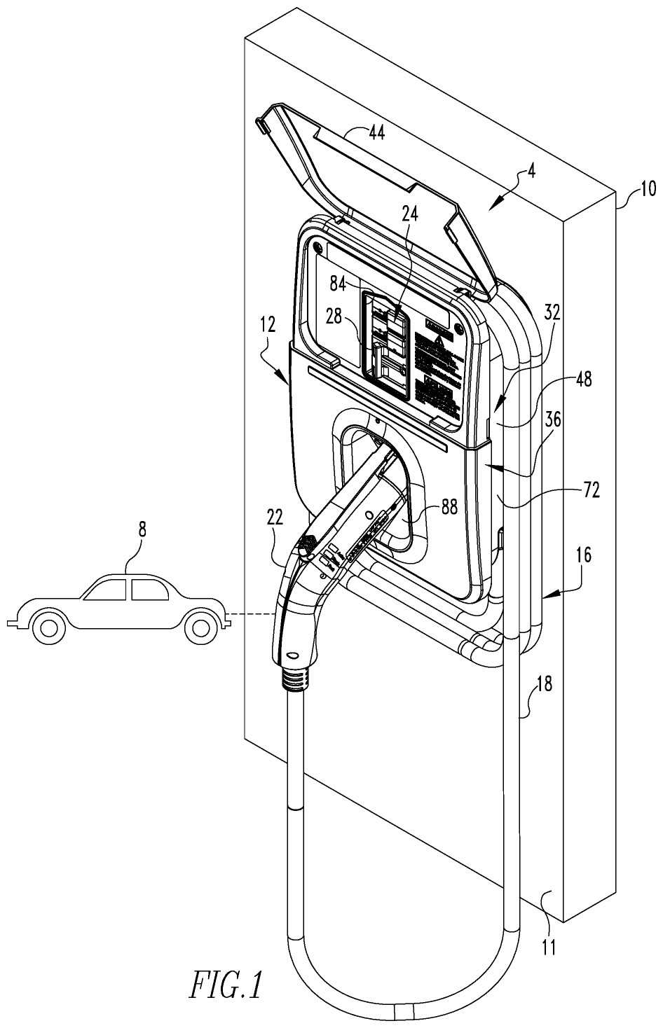

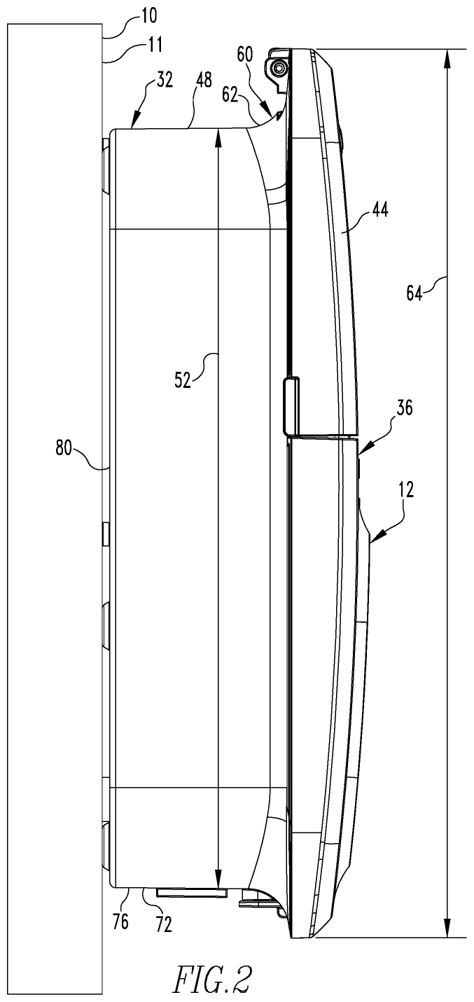

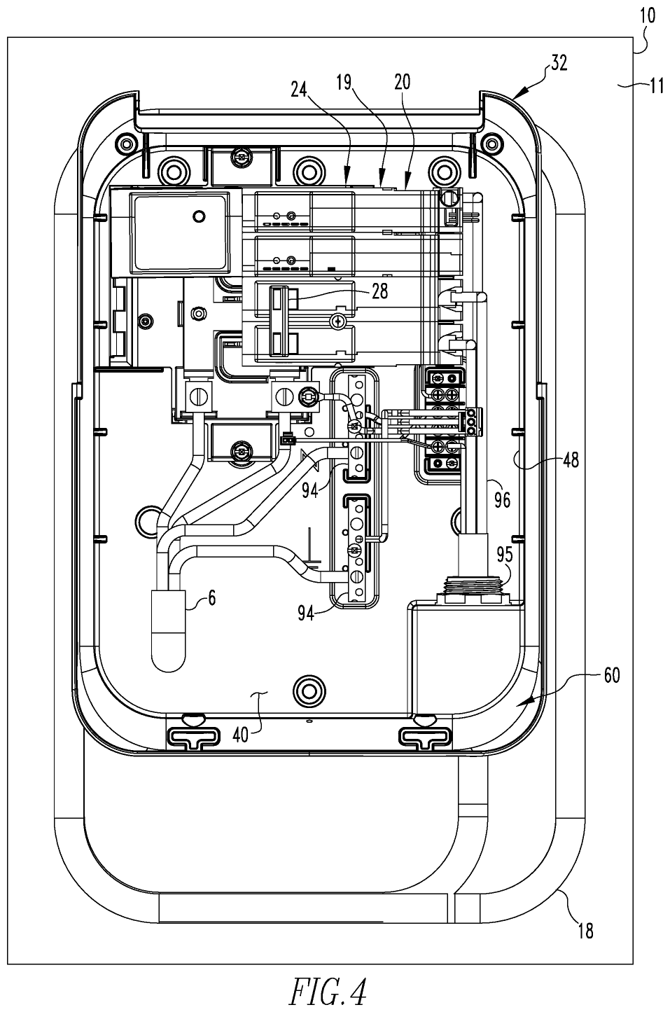

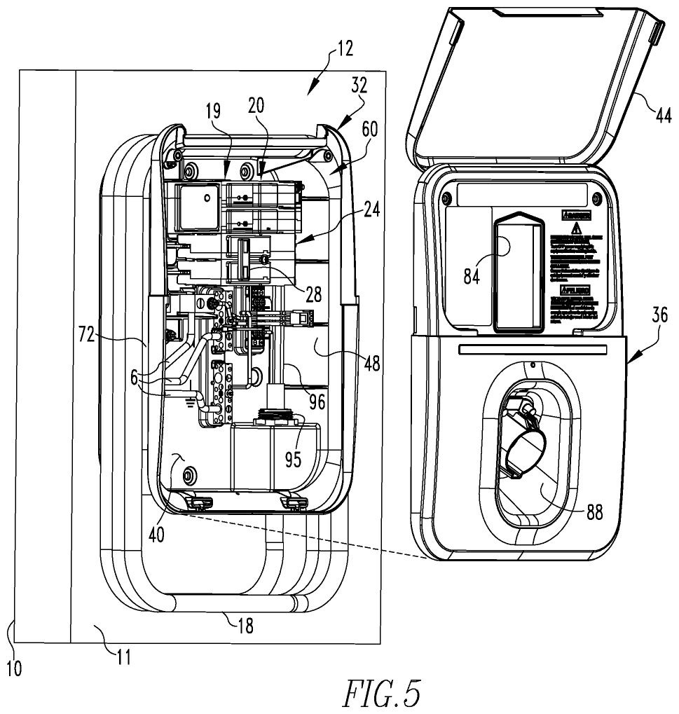

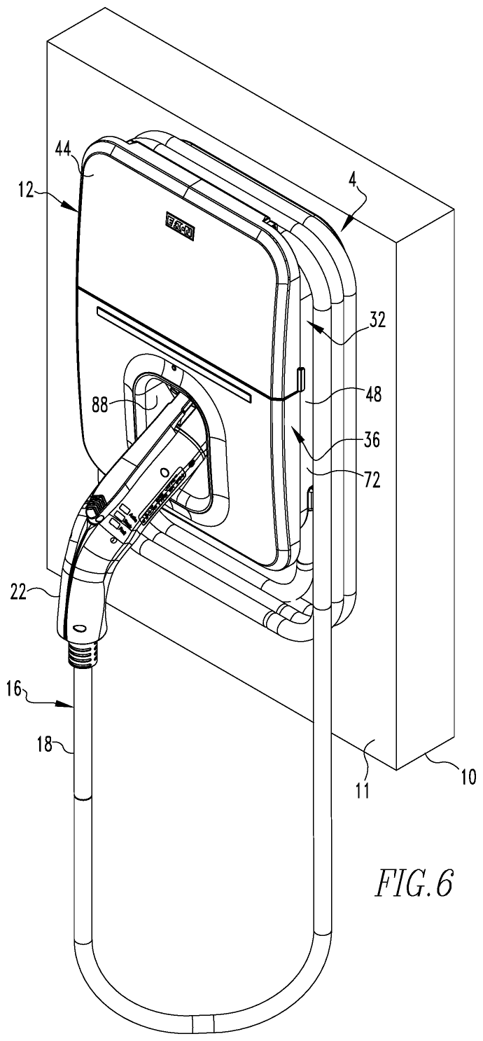

An improved charging apparatus 4 accordance with the disclosed and claimed concept is depicted generally in FIGS. 1 and 6 and is shown in part in FIGS. 2-4. The charging apparatus 4 is structured to be electrically connected with a source of electrical power 6, such as is shown in FIGS. 4-5, having a number of poles and is usable to provide electrical power to an electric vehicle 8 in order to charge the electric vehicle 8. As employed herein, the expression “a number of” shall refer broadly to any non-zero quantity, including a quantity of one. The charging apparatus 4 is mountable to a structure such as a wall 10 or other structure and, as depicted herein, to a planar surface 11 of the wall.

The charging apparatus 4 can be said to include housing 12 upon which is situated a cable apparatus 16 and an electrical apparatus 19, such as is shown in FIG. 4, that is situated on the housing 12 and that includes a circuit interrupter apparatus 20, such as is also shown in FIG. 4. The cable apparatus 16 can be said to include a cable 18 that is elongated and to further include a connector 22. The cable 18 is situated on the housing 12, and the connector 22 is situated at and electrically connected with an end of the cable 18 opposite its connection with the housing 12.

The exemplary circuit interrupter apparatus 20 advantageously includes a circuit interrupter 24 having a handle 28 that is manually operable by a user to switch the circuit interrupter 24 among at least an OFF position, an ON position, and a TRIP position, by way of example. The circuit interrupter apparatus 20 and the circuit interrupter 24 can be any of a wide variety of devices and may, for example and without limitation, be similar to that which is described in U.S. Pat. No. 10,630,089. Depending upon the needs of the application, the source of electrical power 6 can include a single pole, or it can include a pair of poles providing 240 volts, or still alternatively can include a pair of poles providing 208 volts if the poles are from a three-phase system.

Moreover, the circuit interrupter 24 is situated directly on the housing 12 rather than being, for instance, situated electrically upstream of the charging apparatus 4 in a load center or other location remote from the housing 12. This advantageously enables the user, who may be in the process of electrically connecting the cable apparatus 16 with the electric vehicle 8, to easily and quickly switch the circuit interrupter 24 among at least the OFF position, the ON position, and the TRIP position, for instance, should the need arise. This advantageously enables a user to isolate the primary source of electrical power from the cable apparatus 16 by, for instance, switching the circuit interrupter 24 from the ON position to the OFF position, by way of example.

The housing 12 can be said to include a first portion 32 and a second portion 36 that are connected together with fasteners, such as screws and the like. The housing 12 is formed to include an interior 40 shown in FIGS. 4-5, and access to the interior 40 is possible when the second portion 36 is removed from the first portion 32.

The circuit interrupter apparatus 20 is situated generally within the interior 40, although at least a portion of the circuit interrupter apparatus 20 can be exposed to the exterior of the housing 12. More particularly, the housing 12 additionally includes a cover portion 44 that is hingedly mounted to the housing 12 and is specifically mounted to the second portion 36. The cover portion 44 is manually movable by the user between an open condition such as is depicted generally in FIG. 1 wherein the circuit interrupter apparatus 20 is exposed to the exterior of the housing 12, and a closed condition such as is depicted in FIG. 6, wherein the circuit interrupter apparatus 20 is not exposed to the exterior of the housing 12. The user can manually operate and move the cover portion 44 to expose the aforementioned protruding portion of the circuit interrupter 24, by way of example, if the user wishes to manually move the circuit interrupter 24 among at least the OFF position, the TRIPPED position, and the ON position, for instance, should the need arise.

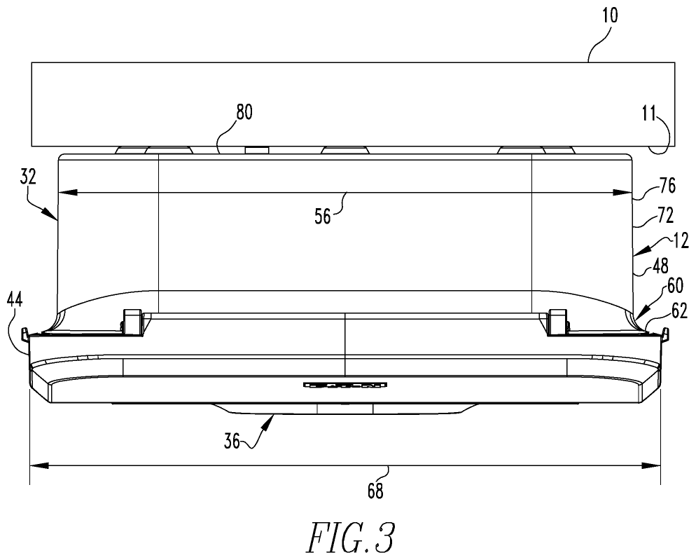

The first portion 32 of the housing 12 can also be considered to include a base portion 48 that has as its transverse dimensions a height 52, such as is depicted generally in FIG. 2, and a width 56, such as depicted generally in FIG. 3. In addition to the base portion 48, the first portion 32 of the housing 12 can additionally be considered to include a retaining portion 60 that is configured to retain the cable 18 on the housing 12 between the retaining portion 60 and the wall 10. The retaining portion 60 extends outwardly from a perimeter 76 of the base portion 48 and is spaced from an exemplary and generally planar mounting surface 80 and the wall 10. The first portion 32 additionally and advantageously include a radiused surface 62 between the perimeter 76 of the base portion 48 and the surface of the retaining portion 60 that faces the wall 10.

The second portion 36 extends across the retaining portion 60 and has as its transverse dimensions another height 64, such as is depicted generally in FIG. 2, and another width 68, such as depicted generally in FIG. 3. The aforementioned transverse dimensions of the base portion 48 and the second portion 36 are depicted as being in directions that are generally parallel with the mounting surface 80 that is formed on the first portion 32. The retaining portion 60 can thus be seen in FIGS. 2 and 3 to be spaced from and to be positioned on the housing 12 opposite the mounting surface 80 and thus spaced therefrom.

In the depicted exemplary embodiment, the another height 64 and the another width 68 of the retaining portion 60 are greater than the height 52 and the width 56, respectively, of the base portion 48. The base portion 48 can be said to include a lateral surface 72, and at least a portion of the cable 18 can be wound about the perimeter 76 of the base portion 48, with the cable 18 specifically engaging and being wrapped about the lateral surface 72 of the base portion 48. Since at least a subset of the transverse dimensions of the retaining portion 60 are greater than the corresponding transverse dimensions of the base portion 48, the retaining portion 60 advantageously retains the cable 18 between the retaining portion 60 and, for instance, the mounting surface 80, at least a portion of which is mounted to or substantially adjacent the surface 11 of the wall 10, when the cable 18 is wrapped about the perimeter 76 of the base 48. This advantageously allows a user to manage the cable 18, during charging of the electric vehicle 8 or after charging of the electric vehicle 8, without simply having to store the cable 18 on the floor, for instance.

As noted elsewhere herein, and as can be understood from FIGS. 2 and 3 and elsewhere herein, the housing 12 further includes the mounting surface 80 formed on the first portion 32. The mounting surface 80 is engaged with the surface 11 of the wall 10 or other structure when the housing 12 is mounted to the wall 10 or other structure, such as with the use of screws or other fasteners.

As is best shown in FIG. 5, the second portion 36 has an opening 84 formed therein within which a portion the circuit interrupter apparatus 20 is situated and extends from the interior 40 of the housing 12. The second portion 36 also has formed thereon a receptacle 88 that is structured to receive therein the connector 22 when it is not in use. This further advantageously allows and facilitates storage of the entire cable apparatus 16 on the housing 12, such as when the cable 18 is wrapped about the perimeter 76 of the base portion 48 and the connector 22 is received in the receptacle 88.

In order to use the charging apparatus 4 to provide electrical power to the electric vehicle 8, the connector 22 is removed from the receptacle 88, the cable 18 is in whole or in part unwound from its position wrapped about the perimeter 76 of the base portion 48 between the retaining portion 60 and the wall 10 and, if applicable, the circuit interrupter is switched to the ON position. The connector 22 is connected with the electric vehicle 8 to cause the electric vehicle 8 to be electrically connected with the source of electrical power 6 via the circuit interrupter apparatus 20 and the cable apparatus 16 to charge the electric vehicle 8. The connector is thereafter detached from the electric vehicle 8, the cable 18 is re-wrapped as needed about the perimeter 76, and the connector 22 is returned to the receptacle 88.

FIG. 4 depicts in a schematic fashion the interior 40 of the housing 12 and more particularly depicts a part of the first portion 32. The electrical apparatus 19 additionally includes a number of connectors 94, such as a screw terminals or other types of connectors that enables each pole of the source of electrical power 6 to be electrically connected with the circuit interrupter 22. The circuit interrupter apparatus 20 further includes a number of line conductors that are not are not expressly depicted but that are situated on the first portion 32 and that electrically connect between the connectors 94 and the circuit interrupter 22. The circuit interrupter apparatus 20 further includes a load conductor 96 that is electrically connected between the circuit interrupter and a connector 95 of the circuit interrupter apparatus 20 that is situated on the first portion 32 and with which is connected the cable 18. The line conductors and the load conductors 96 are situated within the interior 40 and may be in the form of bus bars or other type structures which enable the circuit interrupter apparatus 20 to easily be electrically connected therewith in a fashion similar to the way it which conventional circuit interrupters are mounted to and electrically connected with load centers, by way of example. It thus can be understood that the circuit interrupter apparatus 20 is electrically connected with the source of electrical power 6 and is further electrically connected with the cable apparatus 16. When the circuit interrupter 24 is in its ON position, by way of example, the cable apparatus 16 and the source of electrical power 6 are electrically connected with one another.

As noted elsewhere herein, the circuit interrupter 24 is situated on the housing 12 itself and thus advantageously enables circuit protection, AC power service disconnection and other features to be provided by the circuit interrupter apparatus 20 and to be provided directly on the housing 12. The housing 12 is itself simple to install on the wall 10 and to connect with the source of electrical power 6. Moreover, the provision of the retaining portion 60 and the receptacle 88 advantageously enable the cable apparatus 16 to be managed when in use and when not in use. Other advantages will be apparent.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A charging apparatus that is structured to be mounted to another structure and to be electrically connected with a source of electrical power, comprising:
a housing;
a cable apparatus comprising a cable and a connector that are electrically connected together, the cable extending from the housing;
an electrical apparatus situated on the housing and structured to be electrically connected with the source of electrical power;
the cable apparatus being electrically connected with the electrical apparatus and being structured to provide electrical power from the source of electrical power to an electric vehicle; and
the electrical apparatus comprising a circuit interrupter apparatus situated on the housing, the circuit interrupter apparatus comprising a circuit interrupter that is electrically connected with the cable and that is movable between at least an ON state wherein the cable is electrically connected with the source of electrical power and at least one of an OFF state and a TRIPPED state wherein the cable is electrically disconnected from the source of electrical power.

2. The charging apparatus of claim 1 wherein the housing has a base portion that is structured to be mounted to the another structure, the housing further comprising a retaining portion that is situated on the base portion, at least a portion of the retaining portion protruding from the base portion and being structured to retain at least a portion of the cable between the retaining portion and the another structure when the cable is at least in part wrapped about a perimeter of the base portion.

3. The charging apparatus of claim 2 wherein the base portion has a mounting surface that is structured to be mounted to the another structure, the retaining portion being spaced from the mounting surface.

4. The charging apparatus of claim 3 wherein the mounting surface has a width and a height, and wherein the retaining portion has another width and another height, at least one of:
the another width being greater than the width; and
the another height being greater than the another height.

5. The charging apparatus of claim 1 wherein the housing has includes a cover portion that is movable between a first configuration wherein the circuit interrupter is covered by the cover portion and a second configuration wherein the circuit interrupter is exposed.

6. The charging apparatus of claim 5 wherein the housing has a base portion that is structured to be mounted to the another structure, the housing further comprising a retaining portion that is situated on the base portion, at least a portion of the retaining portion protruding from the base portion and being structured to retain at least a portion of the cable between the retaining portion and the another structure when the cable is at least in part wrapped about a perimeter of the base portion, the cover portion being situated on the retaining portion.

7. The charging apparatus of claim 1 wherein the housing comprises an interior, and wherein the electrical apparatus further comprises a conductor that is situated within the interior and is electrically connected with the circuit interrupter apparatus and is structured to be electrically connected with the source of electrical power.

8. The charging apparatus of claim 1 wherein the circuit interrupter comprises a handle that is user-operable to move the circuit interrupter among at least the ON and OFF states.

9. The charging apparatus of claim 1 wherein the connector is situated on the cable at an end thereof opposite the housing.

10. The charging apparatus of claim 9 wherein the housing comprises a receptacle in which the connector is receivable.

11. A charging apparatus that is structured to be mounted to another structure and to be electrically connected with a source of electrical power, comprising:
a housing;
a cable apparatus comprising a cable and a connector that are electrically connected together, the cable extending from the housing;
an electrical apparatus situated on the housing and structured to be electrically connected with the source of electrical power;
the cable apparatus being electrically connected with the electrical apparatus and being structured to provide electrical power from the source of electrical power to an electric vehicle; and
the housing having a base portion that is structured to be mounted to the another structure, the base portion having a mounting surface that is structured to be mounted to the another structure;
the housing further comprising a retaining portion that is situated on the base portion and is spaced from the mounting surface, at least a portion of the retaining portion protruding outwardly from a perimeter of the base portion and being structured to retain at least a portion of the cable between the retaining portion and the another structure when the mounting surface is mounted to the another structure and when the cable is at least in part wrapped about the perimeter.

12. The charging apparatus of claim 11 wherein the mounting surface has a width and a height, and wherein the retaining portion has another width and another height, at least one of:
the another width being greater than the width; and
the another height being greater than the another height.

13. The charging apparatus of claim 11 wherein the electrical apparatus further comprises a circuit interrupter apparatus situated on the housing, the circuit interrupter apparatus comprising a circuit interrupter that is electrically connected with the cable and that is movable between at least an ON state wherein the cable is electrically connected with the source of electrical power and at least one of an OFF state and a TRIPPED state wherein the cable is electrically disconnected from the source of electrical power.

14. The charging apparatus of claim 13 wherein the housing has includes a cover portion that is movable between a first configuration wherein the circuit interrupter is covered by the cover portion and a second configuration wherein the circuit interrupter is exposed.

15. The charging apparatus of claim 14 wherein the cover portion is situated on the retaining portion.

16. The charging apparatus of claim 13 wherein the housing comprises an interior, and wherein the electrical apparatus further comprises a conductor that is situated within the interior and is electrically connected with the circuit interrupter apparatus and is structured to be electrically connected with the source of electrical power.

17. The charging apparatus of claim 13 wherein the circuit interrupter comprises a handle that is user-operable to move the circuit interrupter among at least the ON and OFF states.

18. The charging apparatus of claim 13 wherein the connector is situated on the cable at an end thereof opposite the housing.

19. The charging apparatus of claim 18 wherein the housing comprises a receptacle in which the connector is receivable.

20. The charging apparatus of claim 19 wherein the receptacle is situated on the retaining portion opposite the mounting surface.
